(19) United States
(12) Patent Application Publication
(10) Pub. No.: US 2024/0403137 A1
(43) Pub. Date: Dec. 5, 2024

(54) RULE-BASED EDGE CLOUD OPTIMIZATION FOR REAL-TIME VIDEO ANALYTICS

(71) Applicant: NEC Laboratories America, Inc., Princeton, NJ (US)

(72) Inventors: Kunal G. Rao, Monroe, NJ (US); Giuseppe Coviello, Robbinsville, NJ (US); Ciro Giuseppe DeVita, Naples (IT); Gennaro Mellone, Napoli (IT); Yuang Jiang, Jersey City, NJ (US); Wang-pin Hsiung, Santa Clara, CA (US); Srimat Chakradhar, Manalapan, NJ (US)

(21) Appl. No.: 18/678,121

(22) Filed: May 30, 2024

Related U.S. Application Data
(60) Provisional application No. 63/470,547, filed on Jun. 2, 2023.

(51) Int. Cl. G06F 9/50

(52) U.S. Cl. CPC G06F 9/5083; G06F 9/5016; G06F 2209/503

(57) ABSTRACT

Systems and methods are provided for dynamically optimizing microservice placement in a distributed edge and cloud computing environment, including receiving application specifications that include telemetry data collection methods, placement rules, and modes of operation, validating the received application specifications to ensure completeness and correctness, and composing an application graph where vertices represent microservices and edges represent connections between the microservices. Availability of resources specified in the application graph is checked, and the microservices are deployed according to initial placement rules. Telemetry data from the deployed microservices and underlying infrastructure is collected and evaluated against the placement rules, and the placement of microservices is dynamically adjusted responsive to a determination that current microservice placement is suboptimal based on the evaluating of the collected telemetry data.

### RELATED APPLICATION INFORMATION

This application claims priority to U.S. Provisional App. No. 63/470,547, filed on Jun. 2, 2023, the contents of which is incorporated herein by reference in its entirety.

### BACKGROUND

### Technical Field

The present invention relates to dynamic optimization of microservice placement in distributed computing environments, and more particularly to a system and method for dynamically managing and adjusting the placement of microservices across edge and cloud infrastructures based on real-time telemetry data and adaptive algorithms to enhance performance, reduce latency, and provide optimal resource utilization for various computing systems and applications.

### Description of the Related Art

In the field of distributed computing and real-time data processing, traditional approaches have focused on leveraging centralized cloud infrastructures to handle computational tasks for applications such as video analytics, autonomous systems, and industrial monitoring. These methods rely on transferring vast amounts of data from edge devices to centralized data centers for processing, which leads to significant latency and bandwidth consumption. As applications increasingly demand real-time responses and low-latency performance, these centralized approaches face limitations, particularly in scenarios requiring dynamic adaptation to fluctuating workloads and resource availability. Existing systems and methods struggle with efficiently managing the placement of microservices across a distributed computing continuum that includes both edge and cloud resources. The static placement of microservices by conventional systems and methods fails to account for the variability in network conditions, computational loads, and real-time data processing needs, resulting in suboptimal performance and resource utilization. Furthermore, traditional methods lack the capability to dynamically adjust microservice placement in response to real-time telemetry data and changing operational conditions, leading to inefficiencies and potential service disruptions.

Moreover, the growing deployment of IoT devices and sensors across various sectors such as smart cities, healthcare, and industrial automation exacerbates the challenges of real-time data processing and management. The reliance on centralized processing models poses significant bottlenecks in handling the high volume and velocity of data generated by these devices. This underscores the need for innovative solutions capable of dynamically optimizing microservice placement across distributed edge and cloud environments, ensuring efficient, low-latency data processing and robust application performance.

### SUMMARY

According to an aspect of the present invention, a method is provided for dynamically optimizing microservice placement in a distributed edge and cloud computing environment, including receiving application specifications that include telemetry data collection methods, placement rules, and modes of operation, validating the received application specifications to ensure completeness and correctness, and composing an application graph where vertices represent microservices and edges represent connections between the microservices. Availability of resources specified in the application graph is checked, and the microservices are deployed according to initial placement rules. Telemetry data from the deployed microservices and underlying infrastructure is collected and evaluated against the placement rules, and the placement of microservices is dynamically adjusted responsive to a determination that current microservice placement is suboptimal based on the evaluating of the collected telemetry data.

According to another aspect of the present invention, a system is provided for dynamically optimizing microservice placement in a distributed edge and cloud computing environment. The system includes a memory storing instructions that when executed by a processor device, cause the system to receive application specifications that include telemetry data collection methods, placement rules, and modes of operation, validate the received application specifications to ensure completeness and correctness, and compose an application graph where vertices represent microservices and edges represent connections between the microservices. Availability of resources specified in the application graph is checked, and the microservices are deployed according to initial placement rules. Telemetry data from the deployed microservices and underlying infrastructure is collected and evaluated against the placement rules, and the placement of microservices is dynamically adjusted responsive to a determination that current microservice placement is suboptimal based on the evaluating of the collected telemetry data.

According to another aspect of the present invention, a computer program product is provided for dynamically optimizing microservice placement in a distributed edge and cloud computing environment, including instructions to receive application specifications that include telemetry data collection methods, placement rules, and modes of operation, validate the received application specifications to ensure completeness and correctness, and compose an application graph where vertices represent microservices and edges represent connections between the microservices. Availability of resources specified in the application graph is checked, and the microservices are deployed according to initial placement rules. Telemetry data from the deployed microservices and underlying infrastructure is collected and evaluated against the placement rules, and the placement of microservices is dynamically adjusted responsive to a determination that current microservice placement is suboptimal based on the evaluating of the collected telemetry data.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustratively depicting an exemplary processing system to which the present invention may be applied, in accordance with embodiments of the present invention;

FIG. 2 is a diagram illustratively depicting a method for dynamically managing and adjusting the placement of microservices for video analytics optimization, in accordance with embodiments of the present invention;

FIG. 3 is a diagram illustratively depicting a method for dynamically managing and adjusting the placement of microservices in distributed computing environments, in accordance with embodiments of the present invention;

FIG. 4 is a diagram illustratively depicting a high-level view of a system and method for dynamically managing and adjusting the placement of application microservices by Rule-based Edge Cloud Optimization (RECO), in accordance with embodiments of the present invention;

FIG. 5 is a diagram illustratively depicting a high-level view of a system and method for dynamically managing and adjusting the placement of application microservices by Rule-based Edge Cloud Optimization (RECO), in accordance with embodiments of the present invention;

FIG. 6 is a diagram illustratively depicting a method for managing and optimizing the deployment and execution of applications across a distributed edge and cloud infrastructure, in accordance with embodiments of the present invention;

FIG. 7 is a diagram illustratively depicting a system and method for predicting collisions based on real-time video analytics using a collision prediction pipeline, in accordance with embodiments of the present invention;

FIG. 8 is a diagram illustratively depicting a high-level view of a system for dynamically optimizing the placement of microservices for real-time video analytics application optimization in distributed computing environments, in accordance with embodiments of the present invention; and

FIG. 9 is a diagram illustratively depicting a high-level view of a system for dynamically managing and adjusting the placement of microservices for video analytics optimization in various environments, in accordance with embodiments of the present invention.

### DETAILED DESCRIPTION

In accordance with embodiments of the present invention, systems and methods are provided for dynamically optimizing the placement of microservices in a distributed edge and cloud computing environment. The invention can enhance performance, reduce latency, and ensure efficient resource utilization by adaptively managing the deployment and execution of microservices based on real-time telemetry data and predefined placement rules. The present invention can address the limitations of traditional static placement methods, which often lead to suboptimal performance and resource inefficiencies in dynamic and heterogeneous computing environments by utilizing a rule-based system for dynamic optimization of microservice placement, leveraging real-time telemetry data and advanced algorithms to adaptively manage computational resources in a distributed computing environment. In various embodiments, by receiving application specifications that include telemetry data collection methods, placement rules, and modes of operation, the system can validate these specifications, compose an application graph, and deploy microservices according to initial placement rules. Through continuous collection and evaluation of telemetry data, the system can dynamically adjust microservice placement in response to changing conditions, ensuring optimal performance.

The present invention can incorporate advanced algorithms and machine learning techniques to predict future workload changes and preemptively adjust microservice placement. It also can support the introduction of additional microservices to bridge communications between distributed deployments, enhancing the robustness and scalability of applications. Real-world applications of this technology span various fields, including real-time traffic monitoring, smart city surveillance, industrial equipment maintenance, autonomous vehicle navigation, healthcare monitoring, and more. The system's ability to adapt to varying workloads and resource availability ensures that critical functions are maintained, and overall system performance can be optimized across diverse use cases, in accordance with aspects of the present invention.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Aspects of the present invention are described below with reference to flowchart illustrations and/or block diagrams of methods, systems, and computer program products according to embodiments of the present invention. It is noted that each block of the flowcharts and/or block diagrams, and combinations of blocks in the flowcharts and/or block diagrams, may be implemented by computer program instructions.

The flowchart and block diagrams in the figures illustrate the architecture, functionality, and operation of possible implementations of systems, methods, and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

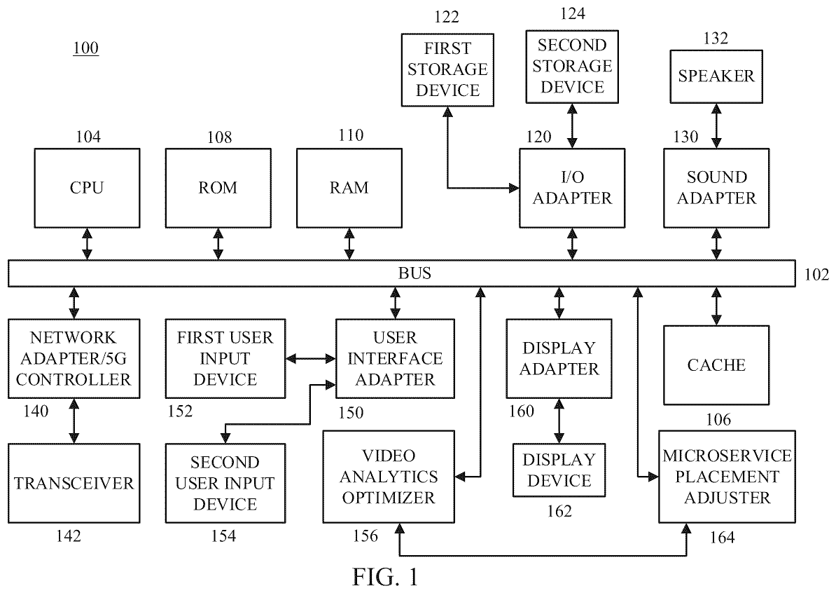

Referring now to the drawings in which like numerals represent the same or similar elements and initially to FIG. 1, an exemplary processing system 100, to which the present principles may be applied, is illustratively depicted in accordance with embodiments of the present principles.

In some embodiments, the processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160. A Vision Language (VL) model can be utilized in conjunction with a predictor device 164 for input text processing tasks, and can be further coupled to system bus 102 by any appropriate connection system or method (e.g., Wi-Fi, wired, network adapter, etc.), in accordance with aspects of the present invention.

A first user input device 152 and a second user input device 154 are operatively coupled to system bus 102 by user interface adapter 150. The user input devices 152, 154 can be one or more of any of a keyboard, a mouse, a keypad, an image capture device, a motion sensing device, a microphone, a device incorporating the functionality of at least two of the preceding devices, and so forth. A video analytics optimizer 156 can optimize any of a plurality of types of video analytics applications by Rule-based Edge Cloud Optimization (RECO), and can be included in a system with one or more storage devices, communication/networking devices (e.g., WiFi, 4G, 5G, Wired connectivity), hardware processors, etc., in accordance with aspects of the present invention. In various embodiments, other types of input devices can also be used, while maintaining the spirit of the present principles. The user input devices 152, 154 can be the same type of user input device or different types of user input devices. The user input devices 152, 154 are used to input and output information to and from system 100, in accordance with aspects of the present invention. The video analytics optimizer 156 can be utilized to work in conjunction with a microservice placement adjuster 164, which can be operatively connected to the system 100 for any of a plurality of tasks (e.g., dynamically adjusting microservice placement in response to real-time telemetry data and changing operational conditions), in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

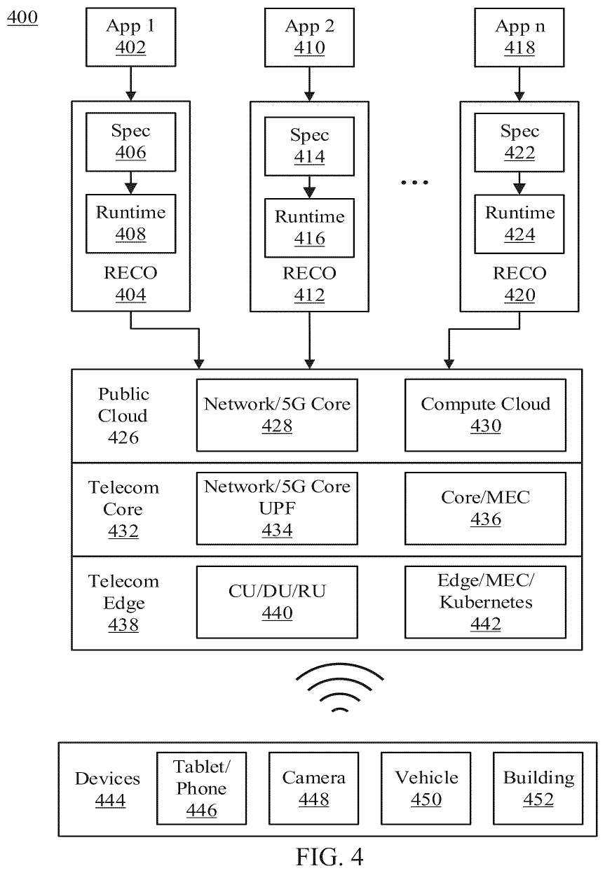

Moreover, it is to be appreciated that systems 400, 500, 700, 800, and 900, described below with respect to FIGS. 4, 5, 7, 8, and 9, respectively, are systems for implementing respective embodiments of the present invention. Part or all of processing system 100 may be implemented in one or more of the elements of systems 400, 500, 700, 800, and 900, in accordance with aspects of the present invention.

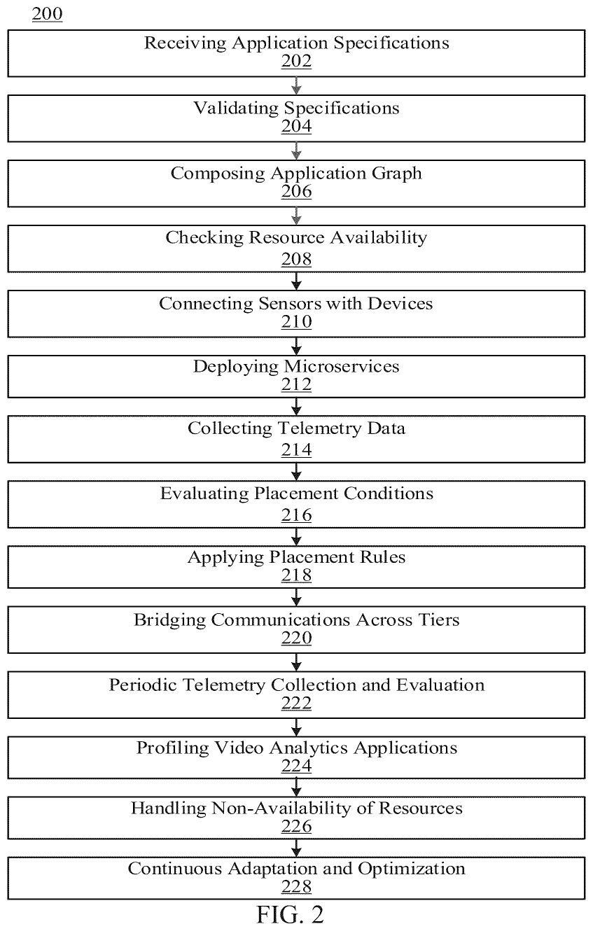

Further, it is to be appreciated that processing system 100 may perform at least part of the methods described herein including, for example, at least part of methods 200, 300, 400, 600, and 700, described below with respect to FIGS. 2, 3, 4, 6, and 7, respectively. Similarly, part or all of systems 400, 500, 700, 800, and 900 may be used to perform at least part of methods 200, 300, 400, 600, and 700 of FIGS. 2, 3, 4, 6, and 7, respectively, in accordance with aspects of the present invention.

As employed herein, the term “hardware processor subsystem,” “processor,” or “hardware processor” can refer to a processor, memory, software, or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Referring now to FIG. 2, a diagram showing a method 200 for dynamically managing and adjusting the placement of microservices for video analytics optimization, is illustratively depicted in accordance with embodiments of the present invention.

In various embodiments, in block 202, application specifications can be received for optimizing video analytics application using Rule-based Edge Cloud Optimization (RECO). These specifications can be provided in, for example, a structured JavaScript Object Notation (JSON) format and include information such as telemetry data collection methods, various modes of operation, initial placement mode for microservices, and intervals for periodic checks. The specifications can be submitted through a user interface, such as a 5g-control-panel component, or via Representational State Transfer (REST) application programming interfaces (APIs) exposed by the 5g-app-pipelines component. This process ensures that the RECO system has sufficient details to manage the dynamic placement of microservices efficiently.

In block 204, the received specifications can be validated to ensure they are complete and correctly formatted. This validation process can include checking the presence of necessary fields such as telemetry data details, modes of operation, placement rules, and connection information. The validation also can include verifying that the JSON syntax is correct and that all referenced resources and services are specified correctly. In block 206, an application graph can be composed based on the validated specifications. The vertices of the graph represent microservices, and the edges represent the connections between these microservices. This graph can serve as a blueprint for deploying the application across the distributed edge and cloud infrastructure. The graph composition can include mapping the microservices to their respective functions within the video analytics pipeline, such as, for example, face detection, feature extraction, and face matching, ensuring all necessary dependencies and communication paths are accurately represented.

In block 208, the RECO runtime system can check the availability of resources specified in the application graph. This can include verifying the presence and readiness of edge and cloud resources, as well as network connectivity. If any resources are unavailable, the system can notify the user, log the issue, and exit the process to avoid partial or faulty execution. This step ensures that the deployment environment meets the requirements specified in the application graph before proceeding. In block 210, the runtime system can connect the sensors with appropriate devices based on the initial placement mode specified in the application specifications. This can include establishing secure connections with IoT devices and ensuring data flow from sensors to the computing infrastructure. The 5g-devices-driver component can periodically check the presence of sensors and retrieve their status (online, offline, or inactive). Once connected, the system can optimally stream data from the sensors to the microservices, in accordance with embodiments of the present invention.

In block 212, the system can deploy the microservices according to the initial placement mode. This can include starting the microservices on the specified tiers (e.g., edge or cloud) and configuring them to begin processing data streams from the connected sensors. The deployment process can include setting up one or more execution environments, such as containers or virtual machines, ensuring that each microservice has sufficient resources and permissions to operate optimally and effectively. In block 214, telemetry data can be collected from the deployed microservices and underlying infrastructure. Telemetry data can include metrics such as, for example, network bandwidth, CPU usage, memory usage, latency, etc., which can be utilized for evaluating the conditions for microservice placement adjustments. The telemetry data collection methods can be specified in the JSON configuration, such as using iPerf3 for network bandwidth measurement or custom scripts for other metrics.

In block 216, the collected telemetry data can be evaluated against the conditions specified in the placement rules. These conditions can be expressed using logical operators (AND, OR) to combine various telemetry metrics and determine if a change in microservice placement is necessary. The evaluation can include comparing the current telemetry data against predefined thresholds or patterns that indicate optimal or suboptimal performance, enabling the system to automatically decide on placement adjustments dynamically. In block 218, upon a determination that the conditions for a different mode of operation are met, the system can dynamically adjust the placement of microservices according to the specified rules. This can include redeploying microservices to different tiers (edge or cloud) to optimize performance based on current workloads. The placement rules can specify which microservices should move to which tiers and under what conditions, ensuring that the application can optimally adapt to changing workloads and resource availability, in accordance with aspects of the present invention.

In block 220, when new placement results in microservices being distributed across multiple DataX deployments, the system can introduce additional microservices to bridge communications. This ensures seamless data flow and coordination between microservices located on different computing tiers. The bridging process can involve setting up intermediary services or proxies that facilitate communication between isolated segments of the distributed system, maintaining the integrity and efficiency of the application pipeline. In block 222, the system can continue to periodically collect telemetry data and re-evaluate the placement conditions. The interval for these periodic checks can be customized and specified in the application specifications (e.g., sleepInterval). This continuous monitoring enables the system to adapt to changes in workload dynamically and in real-time. The periodic checks can include, for example, re-collecting telemetry data, re-evaluating conditions, applying placement rules as deemed necessary by the system, etc., to maintain optimal performance and resource utilization.

In block 224, the RECO system can profile any of a plurality of types of video analytics applications to determine optimal placement strategies for one or more microservices. By running applications in different modes (e.g., offline processing without frame dropping, online real-time processing with possible frame dropping, etc.), RECO can compare results and select the best placement strategies for representative workloads. The profiling process can include using sample videos to simulate various workload scenarios and measure the performance of different placement strategies, enabling the system to make informed decisions about microservice placement.

In block 226, if during any step, the resources become unavailable or are insufficient to meet the application requirements, the system can handle the non-availability by notifying the user, logging the issue, redirecting resources, exiting the deployment process to avoid partial or faulty executions, etc., which ensures that the system can efficiently and optimally handle resource shortages and prevent disruptions in application performance. In block 228, the RECO system can continuously adapt and optimize the placement of microservices in response to ongoing changes in application workload and resource availability. This can include using the collected telemetry data and placement rules to make real-time adjustments to microservice deployment, ensuring that the video analytics application operates efficiently across the edge and cloud continuum. The continuous adaptation process can leverage the profiling results and real-time telemetry data to dynamically optimize resource utilization and application performance, in accordance with aspects of the present invention.

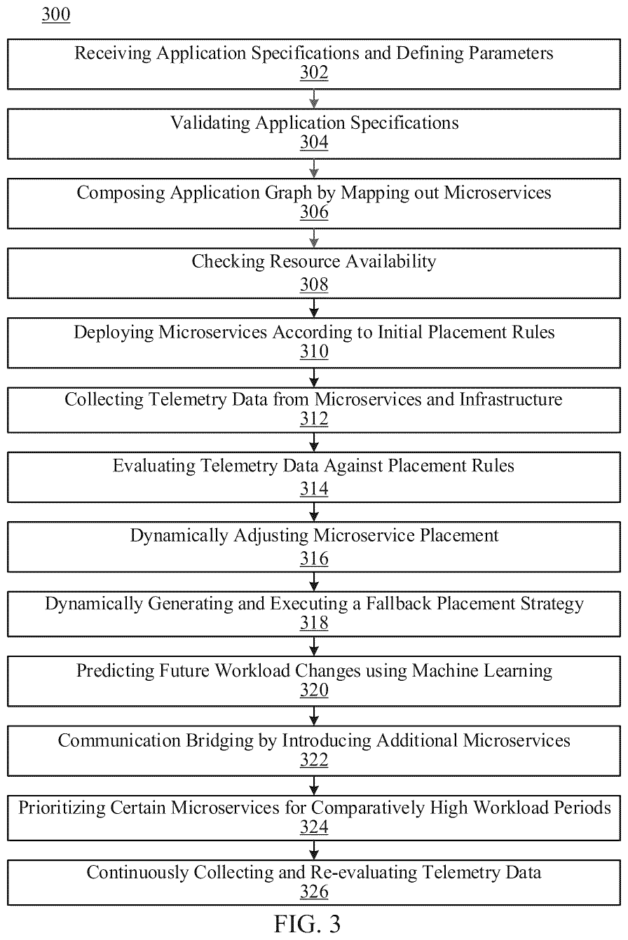

Referring now to FIG. 3, a diagram showing a method 300 for dynamically managing and adjusting the placement of microservices in distributed computing environments, is illustratively depicted in accordance with embodiments of the present invention.

In various embodiments, in block 302, application specifications can be received, which can include telemetry data collection methods, placement rules, and modes of operation. This step can involve parsing input data provided in a structured format, such as JSON or XML, which defines the parameters for telemetry data, specific rules for microservice placement, and various modes under which the application can operate. This data can be sourced from user input through a graphical user interface (GUI) or from predefined configuration files. In block 304, the received application specifications can be validated to ensure completeness and correctness. Validation can include checking that all necessary fields are present, such as telemetry data definitions, placement rules, and modes of operation. The process can involve verifying data types, ranges, and formats, ensuring that the specifications adhere to predefined schemas or standards. This step can also include error handling, where any discrepancies or missing information can be flagged and reported for correction.

In block 306, an application graph can be composed where vertices represent microservices and edges represent connections between the microservices. This graph can be created by mapping out each microservice based on the received specifications, detailing their interactions and dependencies. The graph composition can involve defining communication pathways, data flow, and processing sequences that outline the operational blueprint of the microservices within the distributed environment. In block 308, the availability of resources specified in the application graph can be checked. This step can involve querying the current status of computational resources across edge and cloud environments, such as CPU, memory, storage, and network bandwidth. The system can determine if the necessary resources are available to support the deployment of the specified microservices. If resources are insufficient or unavailable, the system can log the issue and notify the user, pause further deployment steps until resources are confirmed, implement automatic corrective actions (e.g., adjust microservice placement, reconfigure system, etc.), in accordance with aspects of the present invention.

In block 310, microservices can be deployed according to initial placement rules specified in the application specifications. This deployment can involve setting up microservice instances on appropriate nodes within the edge or cloud infrastructure. The system can utilize containerization or virtualization technologies to ensure that each microservice is isolated and can communicate with other services as defined in the application graph. Deployment scripts or orchestration tools can automate this process, ensuring consistency and efficiency. In block 312, telemetry data can be collected from the deployed microservices and underlying infrastructure. This data can include metrics such as network bandwidth, CPU usage, memory consumption, and specific application-related metrics like video frame rate, processing time per frame, and dropped frame count. Collection methods can involve using built-in monitoring tools, custom scripts, or third-party telemetry services to gather and report this data in real-time.

In block 314, the collected telemetry data can be evaluated against the placement rules specified in the application specifications. This evaluation can involve comparing real-time metrics to predefined thresholds or conditions outlined in the placement rules. The system can analyze the data to determine whether the current placement of microservices meets performance and efficiency goals or if adjustments are needed for optimal system performance. In block 316, the placement of microservices can be dynamically adjusted responsive to a determination that the current microservice placement is suboptimal based on the evaluation of the collected telemetry data. Adjustments can include migrating microservices between edge and cloud nodes, scaling resources up or down, or reallocating computational loads to balance performance. The system can use orchestration tools to automate these adjustments, ensuring minimal disruption to the application's operation.

In block 318, a fallback placement strategy can be dynamically generated and executed responsive to resource availability changes during microservice execution. This strategy can provide alternative configurations for microservice placement when primary resources become unavailable or insufficient. The fallback strategy can be predefined or generated in real-time based on current conditions, ensuring continued application functionality under resource constraints. In block 320, machine learning algorithms can be utilized to predict future workload changes based on historical telemetry data. By analyzing past performance and workload patterns, the system can forecast future demands and adjust microservice placement preemptively. This predictive approach can be utilized to optimize resource allocation and improve application responsiveness to changing conditions in real-time, in accordance with aspects of the present invention.

In block 322, additional microservices can be introduced to bridge communications between microservices distributed across multiple DataX deployments. These intermediary services can facilitate data exchange and synchronization, ensuring seamless communication across distributed environments. This step can include deploying additional instances and configuring them to act as communication proxies or brokers. In block 324, the application specifications can be applied, and can include rules for prioritizing and dynamically adjusting microservice placement for microservices deemed critical during periods of high workload. This can ensure consistent performance of essential functions by redistributing computational loads across multiple edge nodes to prevent overloading any single node. Priority rules can be based on the importance of the microservice to overall application functionality and performance objectives. In block 326, telemetry data can be continuously collected and the placement rules re-evaluated at periodic intervals to maintain optimal performance. Continuous monitoring can involve real-time data collection and periodic analysis to ensure that microservice placement remains efficient and effective. Re-evaluation intervals can be defined based on application requirements and workload dynamics, ensuring timely adjustments to changing conditions, in accordance with aspects of the present invention.

Referring now to FIG. 4, a diagram showing a high-level view of a system and method 400 for dynamically managing and adjusting the placement of application microservices by Rule-based Edge Cloud Optimization (RECO), is illustratively depicted in accordance with embodiments of the present invention. The system and method 400 depicts the interaction and data flow between applications, RECO components, and various tiers of the computing infrastructure, showing how different elements within the system can interact to achieve dynamic optimization, in accordance with aspects of the present invention. The system can perform real-time video analytics by leveraging the capabilities of edge computing, 5G networking, and cloud resources. This integration ensures low latency, efficient resource utilization, and high performance, which are particularly useful for applications such as, for example, face recognition, collision prediction, and other real-time analytics tasks.

In various embodiments, in block 402, App 1 can represent a real-time video analytics application deployed within the system. This application can be configured to perform specific tasks such as face recognition, collision prediction, or other video-based analytics. Each application can have its own unique requirements and specifications for telemetry data collection, placement rules, and modes of operation. The application can be developed using a microservices architecture, where each microservice performs a distinct function, such as video frame decoding, feature extraction, or object detection.

In block 404, RECO can act as the central control system for App 1 understanding and can apply specified rules to dynamically update microservice placement as the workload changes. RECO can ensure that the application runs efficiently by optimizing resource usage across edge and cloud environments. The system can leverage advanced algorithms and machine learning techniques to predict future workload changes and preemptively adjust microservice placement. RECO's ability to dynamically adapt to changing conditions ensures that the application maintains low latency and high performance.

In block 406, specifications for App 1 can be received, including, for example, telemetry data collection methods, placement rules, and modes of operation. This specification can define the parameters for how the application should be deployed and managed within the edge and cloud infrastructure. The specification can include details such as the types of telemetry data to be collected (e.g., CPU usage, memory consumption, network latency), the conditions under which microservices should be relocated, and the initial placement configuration. These specifications can be provided in a variety of formats, including a structured format, such as JSON, and can be dynamically updated as deemed necessary by the system and/or end users.

In block 408, the runtime component for App 1 can execute the application according to the provided specifications. The runtime can monitor the application's performance, collect telemetry data, and make dynamic adjustments to optimize the placement of microservices based on real-time data. The runtime system can continuously evaluate the collected telemetry data against the specified placement rules to determine if adjustments are needed. If a change in workload or resource availability is detected, the runtime can migrate microservices to different nodes or tiers to maintain optimal performance.

In block 410, App 2 can represent an additional real-time video analytics application within the system, similar to App 1 but with potentially different specifications and operational requirements. Each application can have its own set of microservices, telemetry data, and placement rules, allowing for tailored optimization strategies. The applications can run concurrently, with RECO managing the placement of their respective microservices to ensure efficient resource utilization and minimal interference. In block 412, RECO can apply the specified rules for App 2, dynamically adjusting the placement of microservices as the workload changes to maintain efficient operation. RECO can coordinate with the runtime system to ensure that microservices are deployed and managed according to the latest telemetry data and placement rules. This continuous adjustment helps to optimize the use of computational resources and improve the application's performance.

In block 414, the specifications for App 2 can be detailed, outlining the methods for telemetry data collection, placement rules, and modes of operation specific to this application. The specification can include parameters such as the desired response time, acceptable latency thresholds, and conditions for triggering microservice migration. By providing detailed specifications, the system can ensure that each application operates optimally within the distributed computing environment. In block 416, the runtime component for App 2 can manage the execution of the application based on the provided specifications, ensuring optimal performance and resource allocation. The runtime system can continuously monitor the application's telemetry data, compare it against the specified rules, and make necessary adjustments to the microservice placement. This dynamic management helps to prevent resource bottlenecks and ensures that the application can handle varying workloads efficiently.

In block 418, App n can represent additional real-time video analytics applications within the system, each with potentially unique specifications and requirements. The system can support multiple applications running simultaneously, with RECO managing the placement of their microservices to ensure efficient resource utilization and minimal interference. Each application can be independently configured and managed, allowing for tailored optimization strategies based on the specific needs of each application. In block 420, RECO can oversee the execution of App n, applying the specified rules to dynamically optimize microservice placement based on real-time telemetry data. RECO can ensure that the application runs efficiently by optimizing resource usage across edge and cloud environments. The system can leverage advanced algorithms and machine learning techniques to predict future workload changes and preemptively adjust microservice placement.

In block 422, the specifications for App n can be defined, including methods for telemetry data collection, placement rules, and modes of operation. These specifications can be provided in a structured format, such as JSON, and can be dynamically updated as needed. The specifications can define the parameters for deploying and managing the application within the distributed computing environment, ensuring optimal performance and resource utilization. In block 424, the runtime component for App n can execute the application according to the provided specifications, collecting telemetry data and making dynamic adjustments as deemed necessary. The runtime system can continuously evaluate the collected telemetry data against the specified placement rules to determine if adjustments are needed. If a change in workload or resource availability is detected, the runtime can migrate microservices to different nodes or tiers to maintain optimal performance.

In various embodiments, in block 426, a public cloud can provide scalable computing resources that can be leveraged by the RECO system for deploying and managing microservices. The public cloud can handle large-scale data processing and storage requirements, allowing the system to offload intensive computational tasks from edge devices. By integrating public cloud resources, the system can ensure that it has access to sufficient computational power to handle varying workloads and maintain optimal performance. In block 428, the network/5G core can facilitate high-speed data transfer between edge devices and cloud resources. This component can ensure low latency and reliable connectivity, which can be particularly useful for real-time video analytics applications. The 5G core can provide sufficient bandwidth and network slicing capabilities to support the comparatively high data transfer rates necessary for processing video streams and other real-time data.

In block 430, the compute cloud can provide additional computational resources for processing intensive tasks that cannot be handled solely by edge devices. This tier can be used for comparatively complex data analysis and storage, allowing the system to leverage the computational power of cloud data centers to process large volumes of data efficiently. The compute cloud can also provide redundancy and failover capabilities, ensuring that the system remains operational even if some edge devices become unavailable. In block 432, a telecom core can integrate with the network infrastructure, managing data traffic and ensuring efficient communication between edge devices and cloud resources. The telecom core can handle tasks such as data routing, load balancing, and traffic prioritization, ensuring that the data flow remains smooth and uninterrupted. By managing the data traffic efficiently, the telecom core can help to minimize latency and improve the overall performance of the system.

In block 434, the network/5G core User Plane Function (UPF) can manage the data flow within the 5G network, optimizing the routing of data to ensure minimal latency and high throughput. The UPF can handle tasks such as packet forwarding, traffic management, and quality of service (QoS) enforcement, ensuring that data is transmitted quickly (e.g., in real-time) and reliably between edge devices and cloud resources. In block 436, the core/Multi-access Edge Compute (MEC) can provide edge computing capabilities comparatively closer (e.g., locally, intranet, etc.) to the data source, reducing latency and improving response times for real-time applications. MEC can enable local data processing and storage, allowing applications to process data near the source and respond quickly to changing conditions. By bringing computation closer to the data source, MEC can help to reduce the amount of data that needs to be transmitted to the cloud, improving overall system efficiency.

In block 438, a telecom edge can be utilized, and can include edge nodes and resources that handle data processing and storage closer to the source, facilitating faster and more efficient data analysis. The telecom edge can provide the appropriate infrastructure for deploying microservices and managing data traffic, ensuring that applications can process data locally and respond quickly to changing conditions. In block 440, a Central Unit (CU), Distributed Unit (DU), and Radio Unit (RU) can work together within the telecom network to manage data traffic and ensure efficient communication between devices and the core network. These units can handle tasks such as signal processing, data routing, and traffic management, ensuring that data is transmitted comparatively quickly (e.g., real-time) and reliably between edge devices and cloud resources.

In block 442, the edge/MEC/Kubernetes can orchestrate the deployment and management of microservices across edge and cloud environments using containerization technologies. Kubernetes can provide the necessary tools for automating the deployment, scaling, and management of containerized applications, ensuring that microservices are deployed efficiently and can scale dynamically to handle varying workloads. In block 444, various IoT devices, such as sensors and cameras, can generate data for analysis. These devices can be connected to the edge and cloud infrastructure to provide real-time insights. The system can collect data from these devices and process it locally or in the cloud, depending on the requirements of the application and the available resources, in accordance with aspects of the present invention.

In block 446, tablets and phones can serve as user interfaces for interacting with the RECO system, allowing users to monitor application performance and make adjustments as needed. These devices can provide real-time feedback on the status of the system and allow users to control and configure applications remotely. In block 448, cameras can capture video data for real-time analytics applications. The video feeds can be processed by microservices deployed across edge and cloud environments, enabling applications to perform tasks such as object detection, face recognition, and collision prediction. The system can optimize the placement of these microservices to ensure low latency and high performance.

In block 450, vehicles equipped with sensors and cameras can generate data for applications such as autonomous driving and collision prediction. The RECO system can optimize microservice placement to ensure timely data processing, enabling vehicles to automatically make real-time driving decisions based on the collected data. The system can handle tasks such as obstacle detection, route planning, and vehicle control, ensuring that autonomous vehicles can operate safely and efficiently. In block 452, smart buildings equipped with IoT devices can generate data for monitoring and automation applications. The RECO system can manage the deployment of microservices to analyze this data efficiently, enabling tasks such as energy management, security monitoring, and building automation. By optimizing microservice placement, the system can ensure that smart buildings operate efficiently and respond quickly to changing conditions, in accordance with aspects of the present invention.

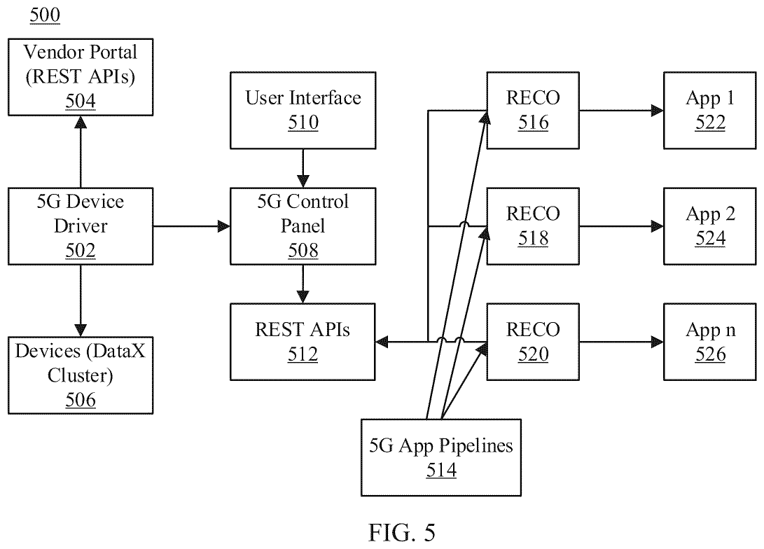

Referring now to FIG. 5, a diagram showing a high-level view of a system and method 500 for dynamically managing and adjusting the placement of application microservices by Rule-based Edge Cloud Optimization (RECO), is illustratively depicted in accordance with embodiments of the present invention. The system and method 500 illustrates the integration and interaction of various components utilized for managing and optimizing microservice placement in a distributed computing environment, in accordance with aspects of the present invention.

In various embodiments, in block 502, a 5G device driver can be utilized to interface with various IoT devices and sensors connected to the 5G network. This device driver can periodically check the presence and status of these devices, determining if they are online, offline, or inactive. By gathering status information from the devices, the 5G device driver ensures that the system is aware of the availability and operational state of all connected sensors and devices. In block 504, a vendor portal can be utilized to provide REST APIs that allow third-party vendors and service providers to interact with the system. These APIs can enable external entities to query the status of devices, update configurations, and retrieve telemetry data. The vendor portal facilitates seamless integration with external systems and ensures that vendors can access and manage their devices within the RECO system.

In block 506, one or more devices (e.g., DataX cluster) can be utilized to represent the physical and virtual IoT devices and sensors that generate data for real-time analytics applications. These devices can include, for example, cameras, environmental sensors, other IoT endpoints that produce telemetry data, etc., and the DataX cluster can provide sufficient computational resources to process data locally, reducing latency and improving response times. In block 508, a 5G control panel can be utilized to serve as the central management console for the system. This component can receive commands from the user interface and manage the lifecycle of applications, including deploying, starting, stopping, and updating microservices. The control panel can also display real-time system information, providing users with up-to-date feedback on the status of applications and system health.

In block 510, the user interface can provide a web-based graphical interface for system administrators and application developers to interact with the RECO system. This interface can enable users to monitor system status, control applications, view telemetry data, and configure system settings. By offering an intuitive and interactive platform, the user interface enhances the user experience and simplifies system management. In block 512, REST APIs can be utilized to facilitate communication between the 5G control panel and other system components, such as 5G-app-pipelines and RECO. These APIs can provide programmatic access to the system, allowing for automated control and management of applications. The REST APIs ensure that commands from the user interface and control panel are executed seamlessly, enabling efficient application lifecycle management.

In block 514, the 5G app pipelines can be utilized to manage the deployment and execution of applications by interfacing with the RECO system. This component can handle tasks such as starting, stopping, updating, and retrieving applications on specified devices. The 5G app pipelines can provide REST APIs for programmatic control and ensure that applications are deployed according to specified requirements. The pipelines can manage the communication and workflow between the control panel and the RECO system, ensuring that applications are optimized for performance and resource utilization. In block 516, the RECO system for App 1 can be utilized to dynamically optimize the placement of microservices based on real-time telemetry data and instructions from 5G app pipelines. RECO can ensure that App 1 runs efficiently by adjusting microservice placement according to predefined rules and real-time conditions. This component can monitor the performance of App 1 and make appropriate adjustments to maintain optimal resource utilization and low latency.

In block 518, the RECO system for App 2 can be utilized similarly to the RECO for App 1, optimizing the placement of microservices based on real-time data and instructions. RECO can dynamically adjust the deployment of App 2 to ensure efficient resource utilization and high performance. By continuously monitoring telemetry data, RECO can respond to changing conditions and workload variations. In block 520, the RECO system for App n can be utilized to manage and optimize the placement of microservices for additional applications within the system. Each RECO instance can operate independently, ensuring that each application is deployed and managed according to its specific requirements and real-time conditions. This modular approach allows the system to support multiple applications simultaneously, each with tailored optimization strategies.

In block 522, App 1 can represent a specific real-time video analytics application deployed within the system. This application can be configured to perform tasks such as face recognition, collision prediction, or other video-based analytics. Each application can have its own unique requirements and specifications, which can be managed by the RECO system to ensure optimal performance. In block 524, App 2 can represent another real-time video analytics application within the system, similar to App 1 but with potentially different specifications and operational requirements. The system can support multiple applications, each managed by its respective RECO instance, ensuring efficient resource utilization and minimal interference. In block 526, App n can represent additional real-time video analytics applications within the system, each with unique specifications and requirements. The system can scale to support multiple applications concurrently, with each application optimized by its respective RECO instance. This scalability ensures that the system can handle varying workloads and application demands, in accordance with aspects of the present invention.

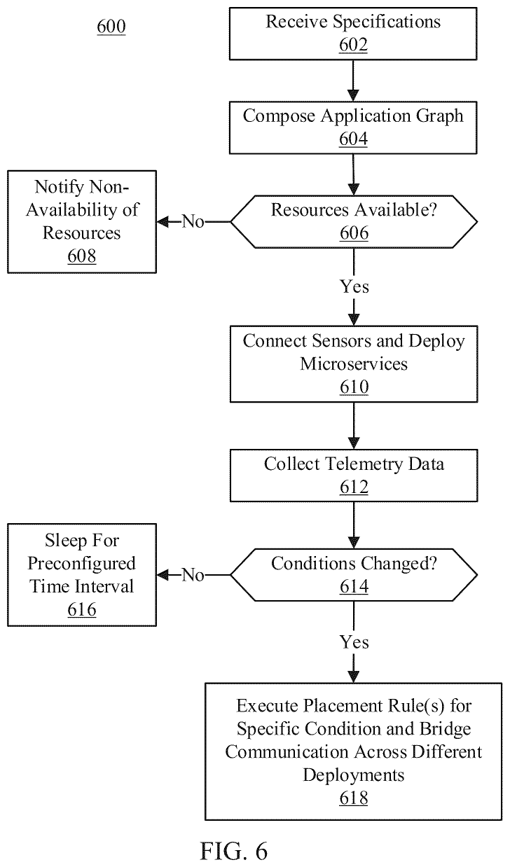

Referring now to FIG. 6, a diagram showing a method 600 for managing and optimizing the deployment and execution of applications across a distributed edge and cloud infrastructure, is illustratively depicted in accordance with embodiments of the present invention. The method 600 can be utilized for dynamically managing the placement of microservices, in accordance with aspects of the present invention.

In various embodiments, in block 602, application specifications can be received as an initial step. This can include gathering detailed specifications for various applications, including telemetry data collection methods, placement rules, and modes of operation. The specifications can be provided in any of a plurality of formats, including, for example, a structured format, such as JSON or XML, and can be utilized for defining how the application should be deployed and managed within the edge and cloud infrastructure for optimal system and application performance. In block 604, an application graph can be composed based on the received specifications. This graph represents microservices as vertices and the connections between them as edges. By mapping out the interactions and dependencies of microservices, the generated application graph can be utilized as a blueprint for deploying the application across the distributed edge and cloud infrastructure. This step ensures that the system has a clear understanding of the application's structure and data flow.

In block 606, availability of resources specified in the application graph can be checked. This can include querying the current status of computational resources across edge and cloud environments, such as CPU, memory, storage, and network bandwidth. If sufficient resources are not available, the system can notify the user of the non-availability of resources, preventing deployment issues and ensuring smooth application execution, and/or take automatic corrective actions, including, for example, adjusting placement of microservices. In block 608, upon a determination that sufficient resources are not available, the system can notify the non-availability of resources, and/or take automatic corrective actions, including, for example, adjusting placement of microservices, in accordance with aspects of the present invention. This notification can be sent to the user or system administrator, informing them of the issue and halting further deployment steps until resources are confirmed. This step ensures that the system does not attempt to deploy applications without the necessary resources, preventing potential failures or inefficiencies.

In block 610, if sufficient resources are available, the system can connect sensors and deploy microservices according to the initial placement rules specified in the application specifications. This can include setting up microservice instances on appropriate nodes within the edge or cloud infrastructure, using containerization or virtualization technologies. The system ensures that sensors are correctly connected to the microservices, enabling real-time data collection and processing. In block 612, telemetry data can be collected from the deployed microservices and underlying infrastructure. This data can include metrics such as network bandwidth, CPU usage, memory consumption, and specific application-related metrics like video frame rate and processing time. The system can continuously monitor these metrics to gather real-time insights into the performance and resource utilization of the application.

In block 614, the system evaluates whether conditions have changed based on the collected telemetry data. This involves comparing real-time metrics to predefined thresholds or conditions outlined in the placement rules. If the conditions have not changed, the system can proceed to sleep for a preconfigured time interval before re-evaluating the telemetry data. If conditions have changed, the system can proceed to the next step to adjust the placement of microservices. In block 616, if conditions have not changed, the system can sleep for a preconfigured time interval. This interval can be defined in the application specifications and determines how frequently the system re-evaluates the telemetry data. This step ensures that the system periodically checks for changes in conditions without consuming excessive computational resources.

In block 618, if conditions have changed, the system can execute the placement rule(s) for the specific condition and bridge communication across different DataX deployments. This can include dynamically adjusting the placement of microservices based on the updated conditions, ensuring optimal performance and resource utilization. The system can selectively introduce additional microservices to bridge communication between different DataX deployments, maintaining seamless data flow and application functionality, in accordance with aspects of the present invention.

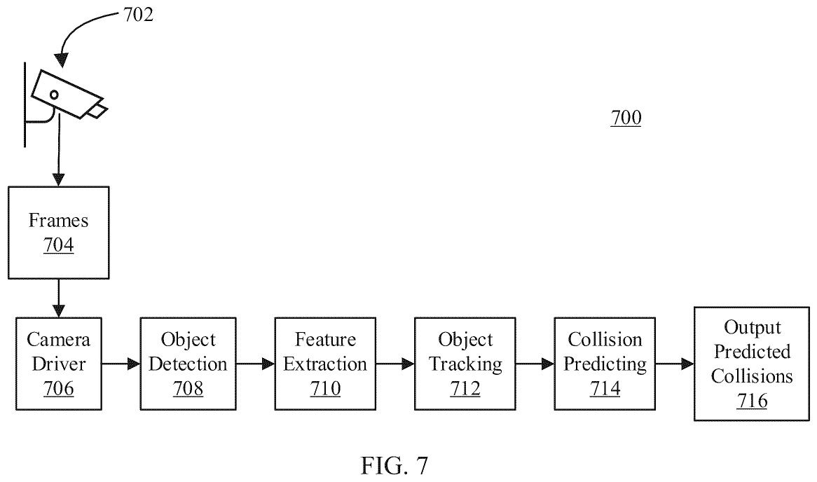

Referring now to FIG. 7, a diagram showing a system and method 700 for predicting collisions based on real-time video analytics using a collision prediction pipeline, is illustratively depicted in accordance with embodiments of the present invention.

In various embodiments, in block 702, a video camera can be utilized to capture real-time video frames, which can be utilized for input for the RECO system. The camera can be positioned to monitor areas where collision prediction is required, such as roads, industrial sites, or public spaces. The captured video frames can serve as the input for the collision prediction pipeline, providing raw data for further processing, in accordance with aspects of the present invention. In block 704, video frames can be received from the camera. These frames represent individual snapshots of the video feed and contain visual information that will be analyzed by subsequent stages in the pipeline. The frames can be processed sequentially to ensure real-time analysis and collision prediction.

In block 706, a camera driver can be utilized to decode video frames from the camera and prepare them for further processing. The camera driver can handle tasks such as frame extraction, resolution adjustment, and format conversion. By decoding the frames, the camera driver ensures that the data is in a suitable format for the next stages of the pipeline. In block 708, object detection can be performed to identify and locate objects within the video frames. This stage can include using machine learning models or computer vision algorithms to detect objects such as vehicles, pedestrians, machinery, etc., and the detected objects can be represented by, for example, bounding boxes that indicate their positions within the frame. This object detection can provide the foundational data for utilization for subsequent feature extraction and tracking.

In block 710, feature extraction can be utilized to extract unique features from the detected objects. These features can include attributes such as shape, color, texture, and other distinguishing characteristics. Feature extraction helps in differentiating objects and provides the necessary data for accurate object tracking. This stage ensures that each object is represented by a set of features that can be tracked over time. In block 712, object tracking can be performed to follow the movement of detected objects across consecutive video frames. This stage can include associating detected objects with their corresponding features from one frame to the next, creating a continuous trajectory for each object. Object tracking algorithms (e.g., Kalman filters, optical flow, etc.) can be used to predict the positions of objects in future frames. This tracking can provide, in real time, temporal data utilized as input for collision prediction.

In block 714, collision predicting can be utilized to analyze the trajectories of tracked objects and predict potential collisions. This stage can include calculating the likelihood of collisions based on the relative positions, speeds, and directions of objects. Machine learning models or mathematical algorithms can be employed to assess collision risks and generate predictions. Collision predicting ensures that potential collisions can be identified in advance, allowing for timely interventions and corrective actions. In block 716, predicted collisions can be outputted as the final stage of the pipeline. This output can include detailed information about the predicted collisions, such as the time, location, and objects involved. The predictions can be used to trigger alerts, initiate automatic preventive actions, or guide decision-making processes, in accordance with aspects of the present invention.

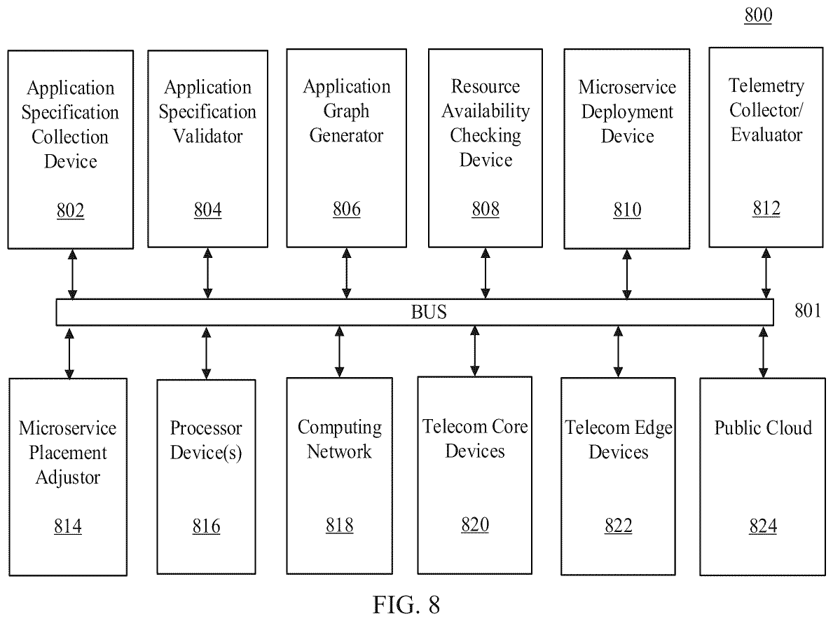

Referring now to FIG. 8, a diagram showing a high-level view of a system 800 for dynamically optimizing the placement of microservices for real-time video analytics application optimization in distributed computing environments, is illustratively depicted in accordance with embodiments of the present invention. The various interconnected components of the system 800 can be utilized to ensure efficient resource utilization, low latency, and high performance across edge and cloud infrastructures, in accordance with aspects of the present invention.

In various embodiments, an application specification collection device 802 can be utilized to gather detailed specifications for various applications. These specifications can include telemetry data collection methods, placement rules, and modes of operation. The device can interface with application developers or system administrators to receive input through structured formats such as JSON or XML. This ensures that all relevant parameters for deploying and managing the applications are captured accurately. An application specification validator 804 can be utilized to ensure the completeness and correctness of the received application specifications. This device can perform checks to verify the presence of required fields, validate data types, and ensure adherence to predefined schemas. By identifying and flagging any discrepancies or missing information, the validator helps maintain the integrity of the application deployment process.

An application graph generator 806 can be utilized to compose an application graph based on the validated specifications. This graph can represent microservices as vertices and the connections between them as edges. By mapping out the interactions and dependencies of microservices, the graph generator creates a blueprint for deploying the application across the distributed edge and cloud infrastructure. A resource availability checking device 808 can be utilized to verify the availability of computational resources specified in the application graph. This device can query the current status of resources across edge and cloud environments, such as CPU, memory, storage, and network bandwidth. By ensuring that sufficient resources are available, the device helps prevent deployment issues and ensures smooth application execution.

A microservice deployment device 810 can be utilized to deploy microservices according to initial placement rules specified in the application specifications. This device can use containerization or virtualization technologies to set up microservice instances on appropriate nodes within the edge or cloud infrastructure. Deployment scripts or orchestration tools can automate this process, ensuring consistent and efficient deployment. A telemetry collector/evaluator 812 can be utilized to collect and evaluate telemetry data from deployed microservices and underlying infrastructure. This device can gather metrics such as network bandwidth, CPU usage, memory consumption, and specific application-related metrics like video frame rate and processing time. By evaluating this data against the placement rules, the device helps determine if adjustments are needed to optimize microservice placement.

A microservice placement adjustor 814 can be utilized to dynamically adjust the placement of microservices based on the evaluation of collected telemetry data. This device can migrate microservices between edge and cloud nodes, scale resources up or down, and reallocate computational loads to maintain optimal performance. The adjustor ensures that the application adapts to changing workloads and resource availability. One or more processor devices can be utilized to execute the various components and functionalities of the RECO system. These processors can handle the computational tasks required for validating specifications, generating application graphs, checking resource availability, deploying microservices, collecting telemetry data, and adjusting microservice placement. Utilization of comparatively high-performance processors ensures that the system operates efficiently and responds quickly to changing conditions.

A computing network 818 can be utilized to facilitate communication and data transfer between the different devices within the system. This network can include comparatively high-speed connections, such as 5G and Ethernet, ensuring low latency and reliable data transmission. The computing network supports the distributed nature of the system, allowing edge and cloud resources to work seamlessly together. One or more telecom core devices 820 can be utilized to manage data traffic and ensure efficient communication within the telecom network. These devices can handle tasks such as data routing, load balancing, and traffic prioritization. By managing the flow of data between edge devices and cloud resources, the telecom core devices help maintain smooth and efficient operation of the system. One or more telecom edge devices 822 can be utilized to provide computational and storage resources closer to the data source. These devices can process data locally, reducing latency and improving response times for real-time applications. The telecom edge devices can handle tasks such as initial data processing, local storage, and intermediate computations, ensuring efficient data handling at the edge of the network. A public cloud 824 can be utilized to provide scalable computing resources for handling large-scale data processing and storage requirements. The public cloud can offload intensive computational tasks from edge devices, ensuring that the system has access to sufficient computational power to handle varying workloads. By integrating public cloud resources, the system can leverage the capabilities of cloud data centers to process data efficiently and maintain optimal performance, in accordance with aspects of the present invention. In block 801, a system integration bus can act as the communication backbone for the architecture, connecting all components. It facilitates the efficient exchange of data and control signals across the system, ensuring coherence and coordinated operations across the network, in accordance with aspects of the present invention.

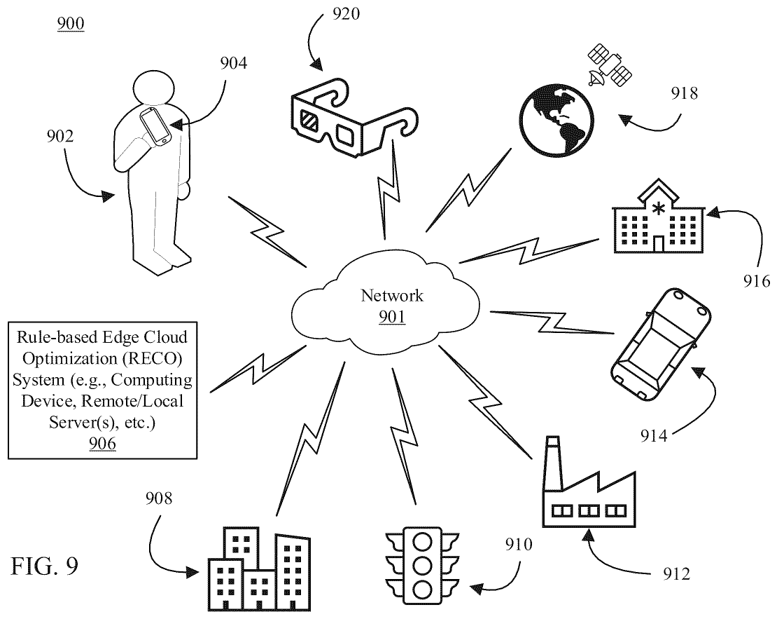

Referring now to FIG. 9, a diagram showing a high-level view of a system 900 for dynamically managing and adjusting the placement of microservices for video analytics optimization in various environments, is illustratively depicted in accordance with embodiments of the present invention. FIG. 9 illustrates various practical, real-world applications utilizing the Rule-Based Edge Cloud Optimization (RECO) system of the present invention.

In various embodiments, one or more end-users 902 who interact with the RECO system are illustratively depicted. These users can receive real-time data, alerts, and insights from the system, allowing them to make informed decisions and take appropriate actions. The user can be anyone from a system administrator to a field operator, who relies on the system's insights for various applications. A user device 904 (e.g., smartphone, tablet, PC, etc.) including a user interface is depicted, representing the devices used by users to interact with the RECO system. This interface can provide access to real-time data, system status, and control functionalities, allowing users to monitor and manage applications remotely. The user interface can be a web-based application or a dedicated mobile app that connects to the RECO system via the network. The Rule-based Edge Cloud Optimization (RECO) system 906 can be any type of computing device (e.g., remote/local server, or other processing unit that manages and optimizes microservice placement). The RECO system can apply advanced algorithms and machine learning techniques to dynamically adjust microservice placement based on real-time telemetry data and predefined rules. This ensures optimal performance, resource utilization, and responsiveness across different applications.

In block 908, smart city surveillance and security can be enhanced by deploying microservices that perform real-time video analytics for monitoring public areas, detecting unusual activities, and responding to security threats. The system can optimize microservice placement to balance load and ensure rapid response. This can be achieved by, for example, integrating video feeds from various surveillance cameras across the city, applying advanced analytics to identify suspicious behavior or unauthorized access, coordinating with law enforcement agencies by sending alerts and actionable insights, and/or dynamically adjusting the placement of microservices to handle varying security demands and ensure continuous monitoring.

In block 910, real-time traffic monitoring and management can be achieved by deploying microservices that analyze video feeds from traffic cameras to detect congestion, accidents, and other incidents. The system can dynamically optimize the placement of microservices between edge and cloud environments to ensure low latency and high reliability in processing video streams. This can be done by receiving live video feeds from traffic cameras and edge sensors, processing video data in real-time to identify traffic patterns, incidents, and anomalies, using machine learning algorithms to predict traffic flow and adjust signal timings accordingly and/or redistributing computational tasks based on current traffic conditions and resource availability.

In block 912, industrial equipment monitoring and maintenance can be facilitated by deploying microservices that analyze sensor data from machinery to predict failures, schedule maintenance, and optimize performance. The system can ensure efficient data processing and timely interventions by adjusting microservice placement. This can be done by collecting sensor data from industrial equipment, such as temperature, vibration, and pressure readings, using predictive maintenance algorithms to identify potential failures and schedule repairs, deploying microservices on edge devices for immediate data analysis and alerts, and/or shifting computational tasks to cloud environments for deeper analytics and historical data comparison.

In block 914, autonomous vehicle navigation and control can be enhanced by deploying microservices that process sensor data and video feeds from autonomous vehicles to make real-time driving decisions. The system can optimize microservice placement to ensure quick data processing and reliable vehicle control. This can be achieved by integrating data from LIDAR, cameras, and other vehicle sensors, processing this data in real-time to detect obstacles, plan routes, and control vehicle movements, utilizing edge computing for immediate response and cloud computing for complex decision-making, and/or dynamically adjusting microservice placement based on vehicle location, network conditions, and computational load.

In block 916, healthcare and remote patient monitoring can be improved by deploying microservices that analyze data from wearable devices and medical sensors to monitor patient health, detect anomalies, and provide alerts. The system can ensure continuous and accurate monitoring by optimizing microservice placement. This can be done by collecting data from wearable devices and medical sensors, such as heart rate, blood pressure, and glucose levels, analyzing this data in real-time to detect health issues and send alerts to healthcare providers, using machine learning to predict potential health risks and recommend preventive measures, and/or adjusting microservice placement to balance load and ensure reliable data processing.

In block 918, agricultural and environmental monitoring and implementing corrective actions can be performed based on rule-based edge cloud optimization (RECO) in accordance with aspects of the present invention. Precision farming and disaster response can be enhanced by this monitoring and corrective action implementation by deploying microservices that analyze data from environmental sensors to detect natural disasters, monitor air and water quality, and coordinate response efforts. The system can ensure timely and effective responses by optimizing microservice placement. This can be done by collecting data from environmental sensors, such as weather stations, air quality monitors, and water level sensors, analyzing this data in real-time to detect and predict natural disasters like floods, earthquakes, and wildfires, sending alerts and coordinating response efforts with emergency services and local authorities, and/or adjusting microservice placement to ensure reliable data processing and communication during emergencies.

The agricultural monitoring and precision farming can be facilitated by deploying microservices that analyze data from agricultural sensors and drones to monitor crop health, optimize irrigation, and improve yield. The system can enhance farming efficiency and sustainability by optimizing microservice placement. This can be achieved by collecting data from soil sensors, weather stations, and aerial drones, using analytics to monitor soil moisture, nutrient levels, and crop health, optimizing irrigation and fertilization schedules based on real-time data, and/or redistributing computational tasks between edge and cloud to handle data from large and dispersed farming areas.

In block 920, enhanced user experience in AR/VR can be achieved by deploying microservices that process real-time data from AR/VR devices to deliver immersive experiences. The system can ensure low latency and high performance by optimizing microservice placement. This can be done by integrating data from AR/VR devices, including motion sensors, cameras, and user interactions, processing this data in real-time to render high-quality graphics and responsive interactions, utilizing edge computing to minimize latency and cloud computing for complex processing tasks, and/or dynamically adjusting microservice placement based on user location, network conditions, and computational requirements, in accordance with aspects of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for dynamically optimizing microservice placement in a distributed edge and cloud computing environment, comprising:
receiving application specifications that include telemetry data collection methods, placement rules, and modes of operation;
validating the received application specifications to ensure completeness and correctness;
composing an application graph where vertices represent microservices and edges represent connections between the microservices;
checking availability of resources specified in the application graph;
deploying the microservices according to initial placement rules;
collecting and evaluating telemetry data from the deployed microservices and underlying infrastructure against the placement rules; and
dynamically adjusting the placement of microservices responsive to a determination that current microservice placement is suboptimal based on the evaluating of the collected telemetry data.

2. The method of claim 1, further comprising dynamically generating and executing a fallback placement strategy responsive to resource availability changes during microservice execution.

3. The method of claim 1, wherein the telemetry data includes real-time video frame processing metrics, such as frame rate, processing time per frame, and dropped frame count.

4. The method of claim 1, further comprising utilizing machine learning algorithms to predict future workload changes based on historical telemetry data and preemptively adjusting microservice placement accordingly.

5. The method of claim 1, further comprising introducing additional microservices to bridge communications between microservices distributed across multiple DataX deployments.

6. The method of claim 1, wherein the application specifications include rules for prioritizing and dynamically adjusting microservice placement for microservices deemed critical during periods of high workload to ensure consistent performance of essential functions, with the dynamically adjusting microservice placement including redistributing computational loads across multiple edge nodes to prevent overloading any single node.

7. The method of claim 1, further comprising continuously collecting the telemetry data and re-evaluating the placement rules at periodic intervals to maintain optimal performance.

8. A system for dynamically optimizing microservice placement in a distributed edge and cloud computing environment, comprising:
a processor device; and
a memory storing instructions that, when executed by the processor device, cause the system to:
receive application specifications that include telemetry data collection methods, placement rules, and modes of operation;
validate the received application specifications to ensure completeness and correctness;
compose an application graph where vertices represent microservices and edges represent connections between the microservices;
check availability of resources specified in the application graph;
deploy the microservices according to initial placement rules;
collect and evaluate telemetry data from the deployed microservices and underlying infrastructure against the placement rules;
dynamically adjust the placement of microservices responsive to a determination that current microservice placement is suboptimal based on the evaluating of the collected telemetry data.

9. The system of claim 8, wherein the memory further stores instructions that cause the system to dynamically generate and execute a fallback placement strategy responsive to resource availability changes during microservice execution.

10. The system of claim 8, wherein the telemetry data includes real-time video frame processing metrics, such as frame rate, processing time per frame, and dropped frame count.

11. The system of claim 8, wherein the memory further stores instructions that cause the system to utilize machine learning algorithms to predict future workload changes based on historical telemetry data and preemptively adjusting microservice placement accordingly.

12. The system of claim 8, wherein the memory further stores instructions that cause the system to introduce additional microservices to bridge communications between microservices distributed across multiple DataX deployments.

13. The system of claim 8, wherein the application specifications include rules for prioritizing and dynamically adjusting microservice placement for microservices deemed critical during periods of high workload to ensure consistent performance of essential functions, with the dynamically adjusting microservice placement including redistributing computational loads across multiple edge nodes to prevent overloading any single node.

14. The system of claim 8, wherein the memory further stores instructions that cause the system to continuously collect the telemetry data and re-evaluate the placement rules at periodic intervals to maintain optimal performance.

15. A computer program product for dynamically optimizing microservice placement in a distributed edge and cloud computing environment, the computer program product comprising a computer readable storage medium having program instructions embodied therewith, the program instructions executable by a hardware processor to cause the hardware processor to:
receive application specifications that include telemetry data collection methods, placement rules, and modes of operation;
validate the received application specifications to ensure completeness and correctness;
compose an application graph where vertices represent microservices and edges represent connections between the microservices;
check availability of resources specified in the application graph;
deploy the microservices according to initial placement rules;
collect and evaluate telemetry data from the deployed microservices and underlying infrastructure against the placement rules;
dynamically adjust the placement of microservices responsive to a determination that current microservice placement is suboptimal based on the evaluating of the collected telemetry data.

16. The computer program product of claim 15, wherein the program instructions further cause the processor to dynamically generate and execute a fallback placement strategy responsive to resource availability changes during microservice execution.

17. The computer program product of claim 15, wherein the program instructions further cause the processor to utilize machine learning algorithms to predict future workload changes based on historical telemetry data and preemptively adjusting microservice placement accordingly.

18. The computer program product of claim 15, wherein the program instructions further cause the processor to introduce additional microservices to bridge communications between microservices distributed across multiple DataX deployments.

19. The computer program product of claim 15, wherein the application specifications include rules for prioritizing and dynamically adjusting microservice placement for microservices deemed critical during periods of high workload to ensure consistent performance of essential functions, with the dynamically adjusting microservice placement including redistributing computational loads across multiple edge nodes to prevent overloading any single node.

20. The computer program product of claim 15, wherein the program instructions further cause the processor to continuously collect the telemetry data and re-evaluate the placement rules at periodic intervals to maintain optimal performance.
